(19) United States
(12) Patent Application Publication
(10) Pub. No.: US 2022/0237687 A1
(43) Pub. Date: Jul. 28, 2022

(54) Image forming apparatus

(71) Applicant: KYOCERA Document Solutions Inc.,, Osaka-shi (JP)

(72) Inventor: Yoshiaki YASUI, Osaka-shi (JP)

(21) Appl. No.: 17/581,000

(22) Filed: Jan. 21, 2022

(30) Foreign Application Priority Data
Jan. 28, 2021 (JP) 2021-011612

(51) Int. Cl. G06Q 30/06; G06V 30/412; H04N 1/00

(52) U.S. Cl. CPC G06Q 30/0635; H04N 1/00209; G06V 30/412

(57) ABSTRACT

The image forming apparatus includes a facsimile device, a controller, an order recording unit, and a reorder time notification unit. The controller controls the facsimile device to transmit the image of the transmission document. The order recording unit (a) detects that the transmission document is an order form for a consumable, (b) specifies order data including at least an order item name and an order date for the order form, and (c) adds the order data to the order history data. The reorder time notification unit transmits a reorder time notification to the user when an order interval of a specific item specified based on the order history data has elapsed from the latest order date of the specific item.

### INCORPORATION BY REFERENCE

This application is based upon and claims the benefit of priority from the corresponding Japanese Patent Application No. 2021-011612 filed on Jan. 28, 2021, the entire contents of which are incorporated herein by reference.

### BACKGROUND

The present disclosure relates to an image forming apparatus.

In a typical system, an image forming apparatus transmits ordering information of a consumable to a server, the server stores the ordering history of each user, selects an advertisement based on the ordering history, and displays the advertisement on the image forming apparatus. When the remaining amount of the consumable in the image forming apparatus becomes less than a predetermined threshold value, the server transmits a message to the image forming apparatus to urge an order of the consumable.

However, in the typical system described above, the ordering of the consumable is prompted based on the remaining amount of the consumable, and for example, if the amount of the consumable used per unit period (1 day, 1 week, etc.) is large, the consumable at the user site may be exhausted and the image forming apparatus may not be usable. Further, since the consumption amount of the consumable per unit period varies depending on the user site, it is difficult to appropriately set the threshold of the remaining the consumable amount for all the user sites (that is, all image forming apparatuses).

The present disclosure provides an image forming apparatus that prompts a user to place an order for the consumable at an appropriate time.

### SUMMARY

The image forming apparatus includes: a facsimile device; a controller controlling the facsimile device and causing the facsimile device to transmit an image of a transmission document; an order recording unit that (a) detects that the transmission document is an order form for a consumable, (b) specifies, with respect to the order form, order data including at least an order item name and an order date, and (c) adds the order data to order history data; and a reorder time notification unit transmitting a reorder time notification to a user when an order interval of a specific item specified based on the order history data has elapsed from the latest order date of the specific item.

### BRIEF DESCRIPTION OF THE FIGURES

FIG. 1 is a block diagram showing a configuration of an image forming apparatus according to an embodiment of the present disclosure.

FIG. 2 is a diagram showing an example of the order history data 16b in FIG. 1.

FIG. 3 is a diagram showing an example of an electronic mail as a reorder time notification.

FIG. 4 is a flowchart for explaining the operation of the image forming apparatus 1 shown in FIG. 1 relating to the reorder time notification.

FIG. 5 is a flowchart for explaining the operation of the image forming apparatus 1 shown in FIG. 1 relating to the facsimile transmission job.

### DETAILED DESCRIPTION

Embodiments of the present disclosure will be described below with reference to the drawings.

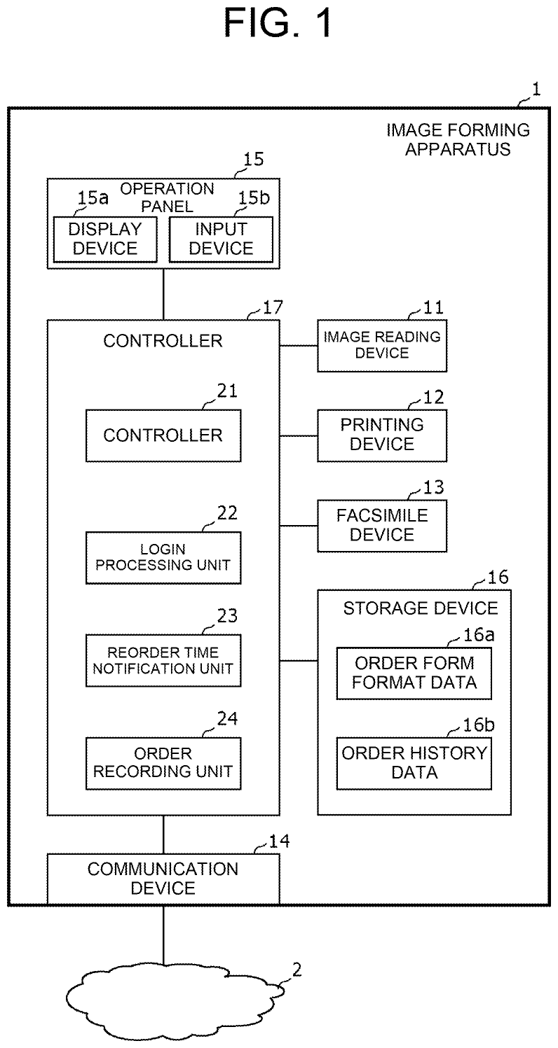

FIG. 1 is a block diagram showing a configuration of an image forming apparatus according to an embodiment of the present disclosure. The image forming apparatus 1 shown in FIG. 1 is, for example, an image forming apparatus such as a multifunction device. The image forming apparatus 1 shown in FIG. 1 includes an image reading device 11, a printing device 12, a facsimile device 13, a communication device 14, an operation panel 15, a storage device 16, a controller 17, and the like.

The image reading device 11 is an internal device for optically reading a document image from a document placed on a platen glass or a document fed by an automatic document feeder at a designated resolution and generating image data of the document image.

The printing device 12 is an internal device for printing a document image or the like by an electrophotographic system or an inkjet system.

The facsimile device 13 is an internal device which transmits a transmission document (image data obtained by scanning or the like) as a facsimile signal, receives the facsimile signal, and generates image data.

The communication device 14 has a network interface and is an internal device connected to the network 2 by the network interface to perform data communication. The communication device 14 may be provided with a peripheral interface such as USB.

The operation panel 15 is disposed on the upper surface side of the housing of the image reading device, and is an internal device having a display device 15a for displaying an operation screen to a user and an input device 15b for receiving a user operation. The display device 15a is a liquid crystal display or the like. The input device 15b is a touch panel or the like which realizes a hard key and a soft key together with the display device 15a.

The storage device 16 is a nonvolatile storage device such as a flash memory for storing data and programs. The storage device 16 stores order form format data 16a and order history data 16b.

For example, the order form format data 16a is data indicating the order form format (items included in the order form and their positions).

The order history data 16b includes order data extracted from a transmission document which is an order form. One piece of order data is generated for each order and added to the order history data 16b.

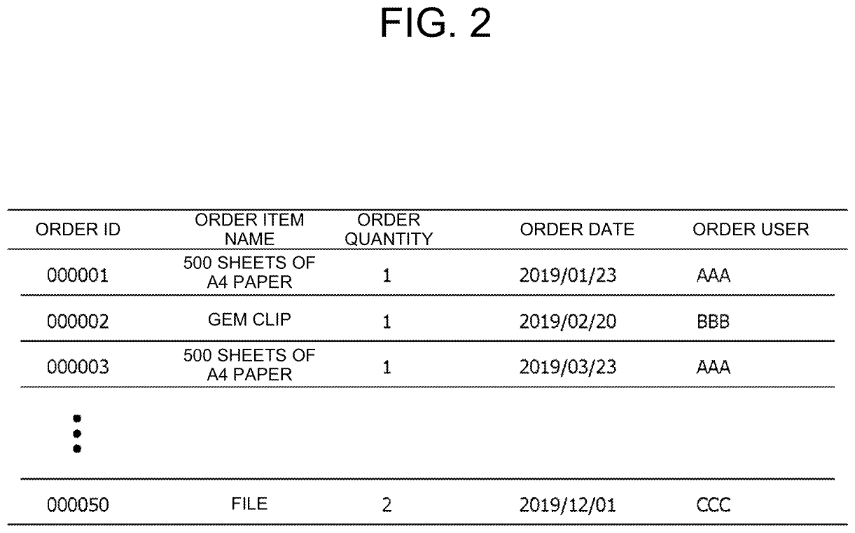

FIG. 2 is a diagram showing an example of the order history data 16b in FIG. 1. For example, as shown in FIG. 2, the order history data 16b includes order data extracted from each previously detected order form, and each order data includes an order ID unique to each order, an order item name, an order quantity, an order date, and an order user.

The controller 17 includes a computer having a Central Processing Unit (CPU), a Read Only Memory (ROM), a Random Access Memory (RAM), and the like, and operates as various processing units. The controller 17 loads a program stored in the ROM or the storage device 16 into the RAM, executes the program by the CPU, and operates as various processing units by software. Here, the controller 17 operates as the controller 21, the login processing unit 22, the reorder time notification unit 23, and the order recording unit 24.

The controller 21 controls the above-described internal device to execute various processes such as a requested job.

For example, upon receiving a facsimile transmission job, the controller 21 acquires image data (such as image data obtained by the image reading device 11) of a transmission document, controls the facsimile device 13, and causes the facsimile device 13 to transmit an image of the transmission document.

Further, in this embodiment, when the transmission document is an order form of a consumable (for example, printing paper, toner cartridges, etc.), the controller 21 (a) specifies, based on the order history data 16b, the latest order date of the name of the ordered item described in the order form with respect to an order user who is different from the order user described in the order form, and (b) if the order interval of the name of the ordered item specified based on the order history data 16b or a predetermined period corresponding to the order interval (for example, a period of half the order interval) has not elapsed from the specified order date, the controller issues a warning to the order user described in the order before the transmission document is transmitted.

Further, in this embodiment, when the transmission document is an order form for a consumable and the consumable (that is, the name of the order item) matches the name of the consumable used in the image forming apparatus 1, the controller 21 may (a) specify the remaining amount information of the consumable and add it to the transmission source information (in this case, TTI) of the transmission document, and (b) cause the facsimile device 13 to transmit an image of the transmission document in which the remaining amount information is added to the transmission source information. Thus, the order destination can judge the delivery urgency of the consumable.

The login processing unit 22 (a) displays a login screen (not shown) on the display device 15a, (b) detects, in the input device 15b, user authentication information input by the user to the login screen, (c) refers to user registration data (not shown) in the storage device 16 to determine whether the input user authentication information is valid, and (d) if the input user authentication information is valid, permits the user to log in and displays an operation screen such as a menu screen on the display device 15a. Thus, the user becomes a login user, and the login user can cause the image forming apparatus 1 to execute a job such as a facsimile transmission job by operating the operation screen. If the input user authentication information is not valid, the login of the user is rejected and the display of the login screen is continued. Instead of referring to the user registration data in the image forming apparatus 1, an authentication server (not shown) may be accessed to make the authentication server determine whether or not the input user authentication information is valid.

A reorder time notification unit 23 transmits a reorder time notification to a user when an order interval of the specific item specified based on the order history data 16b has elapsed from the latest order date of the specific item. For example, the reorder time notification is transmitted as an e-mail. Here, the specific item is a commodity which has been ordered in the past (that is, a commodity whose order item name is included in the order history data 16b), but it may be set in advance by the user instead.

It is to be noted that, repeatedly at predetermined timings (for example, at 0:00 every day), the controller 21 or the reorder time notification unit 23 (a) specifies all the order item names recorded in the order history data 16b, (b) selects the specified order item names in order in the order history data 16b, searches the order data for the selected order item names, specifies the order dates in the discovered order data, specifies the intervals of the specified order dates, and specifies the average, minimum, and maximum values of the intervals as the order intervals of the items (order item names), (c) specifies the latest order date of the items (order item names) in the order history data 16b, and (d) determines whether or not the specified order interval has already elapsed from the latest order date for each order item name (that is, whether or not the reorder scheduled date has arrived), and stores the determination result of the item (order item name) for which reorder scheduled date has arrived, in a storage device 16 or the like.

For example, in the case of the order history data 16b shown in FIG. 2, the order interval of “500 sheets of A4 paper” is specified as 59 days.

When only one piece of order data is found for the selected order item name, the order interval is set to “No”, and no reorder time notification is transmitted for the order item name.

In this embodiment, the reorder time notification unit 23 transmits a reorder time notification to the user when the user has logged in. More specifically, the reorder time notification unit 23 specifies a destination such as an e-mail address of the logged-in user by referring to the user registration data or the like, generates a reorder time notification based on the determination result, and transmits the reorder time notification to the destination.

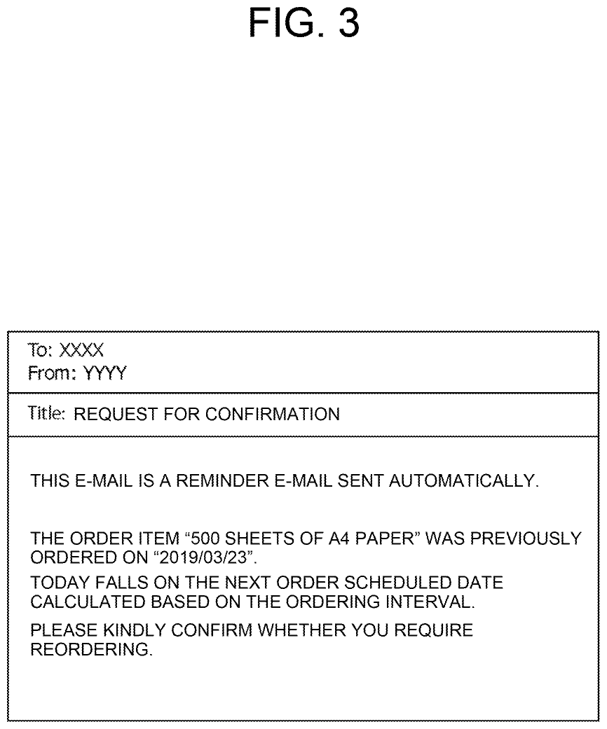

FIG. 3 is a diagram showing an example of an electronic mail as a reorder time notification. For example, as shown in FIG. 3, in the reorder time notification, the name of the order item (the name of the specific item described above), the latest order date, and the reorder scheduled date are described.

The order recording unit 24 (a) detects that the transmission document is an order form for a consumable, (b) specifies order data including at least an order item name and an order date for the order form, and (c) adds the order data to the order history data 16b. In this embodiment, as shown in FIG. 2, the order data includes an order ID unique to each order, an order item name, an order quantity, an order date, and an order user.

In this embodiment, the order recording unit 24 (or the controller 21) refers to the order form format data 16a, and determines that the transmission document is the order form if a description (a predetermined proportion or more) according to the format specified by the order form format data 16a is found in the image of the transmission document, and determines that the transmission document is not the order form if not. It should be noted that the order recording unit 24 may determine whether or not the transmission document is the order form using a machine-learned DNN (deep neural network).

When it is determined that the transmission document is the order form, the order recording unit 24 generates an order ID unique to the order form, and executes a character recognition process for a region designated by the order form format data 16a in the image of the transmission document to specify the value (that is, text data) of the item (order item name, order quantity, order date, and order user).

Next, the operation of the image forming apparatus 1 will be described.

(a) Reorder Time Notification

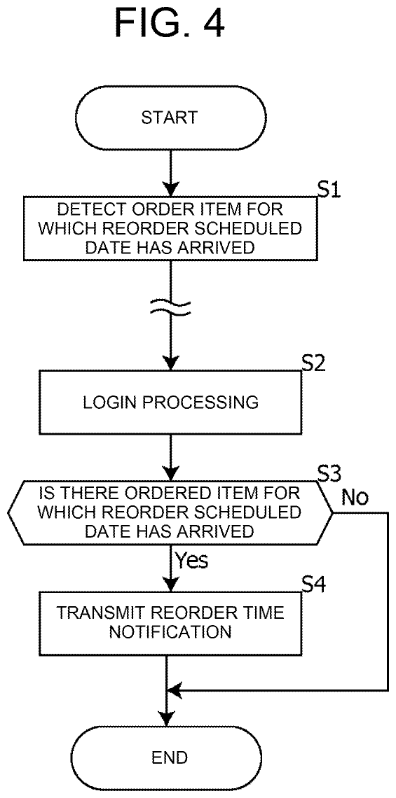

FIG. 4 is a flowchart for explaining the operation of the image forming apparatus 1 shown in FIG. 1 relating to the reorder time notification.

As described above, an item for which reorder scheduled date has already arrived is periodically detected (step S1). Then, when the login processing unit 22 executes the login process for the user who has entered the user ID or the like and the login is permitted (step S2), the reorder time notification unit 23 determines whether or not there is an order item (order item name) for which the order interval has elapsed as described above (step S3).

When there is an order item (order item name) for which the order interval has elapsed at the present time, the reorder time notification unit 23 transmits a reorder time notification as described above (step S4). If there is no such order item, the reorder time notification unit 23 does not transmit the reorder time notification.

When receiving the reorder time notification transmitted in this way, the user determines whether reorder is necessary or not, and if reorder is necessary, the user operates the image forming apparatus 1 to cause the image forming apparatus 1 to perform facsimile transmission of the order form.

(b) Facsimile Transmission

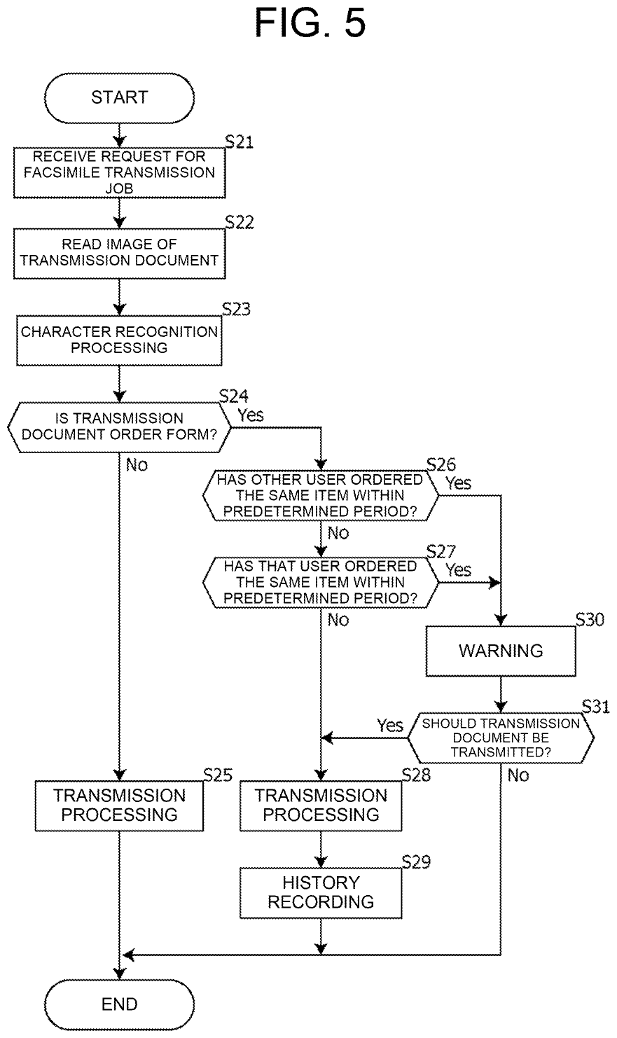

FIG. 5 is a flowchart for explaining the operation of the image forming apparatus 1 shown in FIG. 1 relating to the facsimile transmission job.

When a request for a facsimile transmission job based on a user operation of a login user to an input device 15b is received (step S21), a controller 21 controls an image reading device 11 to make the image reading device 11 read an image of a transmission document, and acquires image data of the transmission document from the image reading device 11 (step S22).

Next, the order recording unit 24 (or the controller 21) refers to the order form format data 16a as described above, performs character recognition processing on the image of the transmission document (step S23), and determines whether or not the transmission document is an order form for a consumable (step S24).

If it is determined that the transmission document is not an order form for a consumable, the controller 21 causes the facsimile device 13 to perform facsimile transmission of the transmission document (step S25).

On the other hand, when it is determined that the transmission document is an order form for a consumable, the controller 21 refers to the order history data 16b and determines whether or not an order user different from the order user described in the order form has ordered the same item within a predetermined period, as described above (step S26).

Similarly, the controller 21 refers to the order history data 16b, and determines whether or not the order user described in the order form has ordered the same item within a predetermined period (the same period as the predetermined period for the different order user or a different period), as described above (step S27).

If it is determined in steps S26 and S27 that the same item is not ordered within a predetermined period of time, the controller 21 causes the facsimile device 13 to perform facsimile transmission of the transmission document (step S28), and the order recording unit 24 generates order data relating to the order and adds the order data to the order history data 16b (step S29).

On the other hand, if it is determined in step S26 or step S27 that the same item has been ordered within a predetermined period, the controller 21 issues a warning to the logged-in user (step S30). This warning is a message indicating that the same item is ordered within a predetermined period, and is displayed on the operation panel 15, or is transmitted as an electronic mail to a destination corresponding to the login user.

After the warning in step S30, the controller 21 waits until a predetermined user operation by the login user is detected by the input device 15b, and when the user operation is detected, the controller determines whether or not facsimile transmission of the transmission document should be executed based on the user operation (step S31).

When it is determined that facsimile transmission of the transmission document should be performed, the controller 21 causes the facsimile device 13 to perform facsimile transmission of the transmission document (step S28), and the order recording unit 24 generates order data relating to the order and adds the order data to the order history data 16b (step S29). On the other hand, when it is determined that the facsimile transmission of the transmission document should not be executed, the controller 21 terminates the job without executing the facsimile transmission of the transmission document.

That is, when the login user performs a user operation for permitting the facsimile transmission of the transmission document, the facsimile transmission of the transmission document is executed; otherwise, the facsimile transmission of the transmission document is not executed and the job ends.

As described above, according to the embodiment, the controller 21 causes the facsimile device 13 to transmit the image of the transmission document. The order recording unit 24 (a) detects that a transmission document is an order form for a consumable, (b) specifies order data including at least an order item name and an order date for the order form, and (c) adds the order data to the order history data. A reorder time notification unit 23 transmits a reorder time notification to a user when an order interval of the specific item specified based on the order history data 16b has elapsed from the latest order date of the specific item.

Thus, the user is urged to order the consumable at an appropriate time in accordance with an order cycle unique to the user site (image forming apparatus 1), and exhaustion of the consumable at the user site is hardly caused.

Various changes and modifications to the embodiments described above will be apparent to those skilled in the art. Such changes and modifications may be made without departing from the object and scope of the subject matter and without diminishing the intended advantage. That is, such changes and modifications are intended to be within the scope of the claims.

For example, in the above embodiment, the order form format data 16a and/or the order history data 16b may be stored in an external device (such as a server), instead of being stored in the built-in storage device 16. In this case, the communication device 14 is used to read and write the order form format data 16a and/or the order history data 16b from and to the external device.

In the above embodiment, the order interval may be derived for each order user or may be derived regardless of the order user.

Further, in the above embodiment, the reorder time notification may be transmitted only once until the reorder is detected after the notification transmission, or may be repeatedly transmitted for each login of the user.

The present disclosure is applicable, for example, to an image forming apparatus such as a multifunction device.

What is claimed is:

1. An image forming apparatus comprising:
a facsimile device;
a controller controlling the facsimile device and causing the facsimile device to transmit an image of a transmission document;
an order recording unit that (a) detects that the transmission document is an order form for a consumable, (b) specifies, with respect to the order form, order data including at least an order item name and an order date, and (c) adds the order data to order history data; and
a reorder time notification unit transmitting a reorder time notification to a user when an order interval of a specific item specified based on the order history data has elapsed from the latest order date of the specific item.

2. The image forming apparatus according to claim 1, wherein:
the reorder time notification unit transmits the reorder time notification to the user when the user has logged in.

3. The image forming apparatus according to claim 1, wherein
the order data further includes an order user, and
when the transmission document is the order form for the consumable, the controller (a) specifies, based on the order history data, the latest order date for the order item name described in the order form with respect to an order user different from an order user described in the order form, and (b) when an order interval for the order item name specified based on the order history data or a predetermined period corresponding to the order interval has not elapsed from the specified order date, the controller issues a warning to the order user described in the order form before transmitting of the transmission document.

4. The image forming apparatus according to claim 1, wherein
when the transmission document is the order form for the consumable, the controller (a) specifies remaining amount information of the consumable and adds the remaining amount information to source information of the transmission document, and (b) causes the facsimile device to transmit the image of the transmission document in which the remaining amount information is added to the source information.
